(19) United States
(12) Patent Application Publication
(10) Pub. No.: US 2025/0095489 A1
(43) Pub. Date: Mar. 20, 2025

(54) TRAINING DATA SERVICE SYSTEM AND METHOD FOR OPERATION SCOPE-ORIENTED AUTONOMOUS SHUTTLE

(71) Applicant: ELECTRONICS AND TELECOMMUNICATIONS RESEARCH INSTITUTE, Daejeon (KR)

(72) Inventors: JU WAN KIM, Daejeon (KR); Jeong-Woo Lee, Daejeon (KR); Kyoung-Wook Min, Daejeon (KR); Jeong Dan Choi, Daejeon (KR)

(21) Appl. No.: 18/751,421

(22) Filed: Jun. 24, 2024

(30) Foreign Application Priority Data
Sep. 14, 2023 (KR) 10-2023-0122338

(51) Int. Cl. G08G 1/0967

(52) U.S. Cl. CPC G08G 1/096741; G08G 1/096708

(57) ABSTRACT

A training data service system for operation scope-oriented autonomous driving shuttle includes a communication module configured to collect an autonomous driving data set from an autonomous driving vehicle to construct training data and distribute the training data to an autonomous driving shuttle, a memory configured to store a program for construction of the training data, and a processor configured to generate query data including road shape information, road attribute information, traffic environment information, and collection sensor information by executing the program stored in the memory, detect data satisfying a condition corresponding to the query data from a previously collected autonomous driving data set, construct training data for the autonomous driving shuttle, based on the detected data, and distribute the constructed training data to a corresponding autonomous driving shuttle.

### CROSS-REFERENCE TO RELATED APPLICATION(S)

This application claims the benefit of the Korean Patent Application No. 10-2023-0122338 filed on Sep. 14, 2023, which is hereby incorporated by reference as if fully set forth herein.

### BACKGROUND

### 1. Field of the Invention

The present invention relates to a training data service system and method for operation scope-oriented autonomous shuttle.

### 2. Description of Related Art

Autonomous driving technology is advancing recently, but autonomous driving in a limited environment is being attempted mainly and preferentially. Particularly, as a trial service, a shuttle-type service is already expanding where autonomous driving is performed along an assigned path in a predetermined environment such as a living lab or a test driving zone.

Autonomous driving artificial intelligence (AI) uses training data without being limited in road environment recently, but in an autonomous driving shuttle service, because autonomous driving is performed in only an assigned zone such as a road or a traffic environment, it is needed to complement training data, based on a corresponding environment.

The use of training data which is not based on a real driving environment may cause undesired data deviation. For example, data of a roundabout zone and a highway zone may be data unnecessary for vehicles which are driving on a road where a shuttle service area is a driving environment of less than 50 Km and there is no roundabout.

In training data which has been currently disclosed, because data is constructed based on labeling data for learning, there is a drawback where training data based on a road shape and a traffic environment may not be appropriately used for learning of autonomous driving vehicles which are driving in an assigned zone like shuttle.

### PRIOR ART REFERENCE

### Patent Document

Korean Patent Publication No. 10-2023-0100928 (2023.07.06)

### SUMMARY

An aspect of the present invention is directed to providing a training data service system and method for operation scope-oriented autonomous shuttle, which may refine and provide training data suitable for road line and attribute information and a traffic environment of a corresponding driving zone, for autonomous driving vehicles such as autonomous driving shuttle driving in an assigned zone.

The objects of the present invention are not limited to the aforesaid, but other objects not described herein will be clearly understood by those skilled in the art from descriptions below.

To achieve these and other advantages and in accordance with the purpose of the invention, as embodied and broadly described herein, there is provided a training data service method for operation scope-oriented autonomous driving shuttle, performed by a computer, the training data service method including: generating query data including road shape information, road attribute information, traffic environment information, and collection sensor information; detecting data, satisfying a condition corresponding to the query data, from a previously collected autonomous driving data set; and constructing training data for an autonomous driving shuttle, based on the detected data.

In some embodiments of the present invention, the generating of the query data may include generating a plurality of query data by subdividing at least one of a zone and a region, where the autonomous driving shuttle is to be driven, each of the plurality of query data may fundamentally include road shape information, and depending on the case, each of the plurality of query data may include at least one of road attribute information, traffic environment information, and collection sensor information.

In some embodiments of the present invention, the detecting of the data satisfying the condition may include: generating first road shape information, based on a moving trajectory of a vehicle provided in the query data and a driving zone of the vehicle corresponding to the moving trajectory; generating second road shape information, based on a moving trajectory of the vehicle provided in the autonomous driving data set and a driving zone of the vehicle corresponding to the moving trajectory; and when the first and second road shape information are within a predetermined similarity range, detecting data for construction of the training data.

In some embodiments of the present invention, each of the generating of the first road shape information and the generating of the second road shape information may include reflecting width information about the vehicle in the moving trajectory of the vehicle to generate the driving zone of the vehicle.

In some embodiments of the present invention, the detecting of the data satisfying the condition may include: aligning initial position of each of the first road shape information and the second road shape information; and performing turn conversion for alignment on the driving zone of each of the first road shape information and the second road shape information where the initial position is aligned.

In some embodiments of the present invention, the detecting of the data for construction of the training data may include calculating a size of an overlap zone of the first and second road shape information, and when the size of the overlap zone is within a predetermined similarity range, detecting the data for construction of the training data.

In some embodiments of the present invention, the detecting of the data satisfying the condition may include: performing similarity comparison on road attribute information provided in the query data, based on metadata associated with a high-precision map included in the autonomous driving data set; and when a similarity is within a predetermined similarity range as a result of the similarity comparison, detecting data for construction of the training data.

In some embodiments of the present invention, the detecting of the data satisfying the condition may include: performing similarity comparison on the traffic environment information provided in the query data, based on attribute information about a moving object include in the autonomous driving data set; and when a similarity is within a predetermined similarity range as a result of the similarity comparison, detecting data for construction of the training data.

In another aspect of the present invention, there is provided a training data service system for operation scope-oriented autonomous driving shuttle, the training data service system including: a communication module configured to collect an autonomous driving data set from an autonomous driving vehicle to construct training data and distribute the training data to an autonomous driving shuttle; a memory configured to store a program for construction of the training data; and a processor configured to generate query data including road shape information, road attribute information, traffic environment information, and collection sensor information by executing the program stored in the memory, detect data satisfying a condition corresponding to the query data from a previously collected autonomous driving data set, construct training data for the autonomous driving shuttle, based on the detected data, and distribute the constructed training data to a corresponding autonomous driving shuttle.

In some embodiments of the present invention, the processor may generate a plurality of query data by subdividing at least one of a zone and a region, where the autonomous driving shuttle is to be driven, each of the plurality of query data may fundamentally include road shape information, and depending on the case, and each of the plurality of query data may include at least one of road attribute information, traffic environment information, and collection sensor information.

In some embodiments of the present invention, the processor may generate first road shape information, based on a moving trajectory of a vehicle provided in the query data and a driving zone of the vehicle corresponding to the moving trajectory, may generate second road shape information, based on a moving trajectory of the vehicle provided in the autonomous driving data set and a driving zone of the vehicle corresponding to the moving trajectory, and when the first and second road shape information are within a predetermined similarity range, may detect data for construction of the training data.

In some embodiments of the present invention, the processor may align an initial position of each of the first road shape information and the second road shape information and may perform turn conversion for alignment on the driving zone of each of the first road shape information and the second road shape information where the initial position is aligned.

In some embodiments of the present invention, the processor may calculate a size of an overlap zone of the first and second road shape information, and when the size of the overlap zone is within a predetermined similarity range, may detect the data for construction of the training data.

In some embodiments of the present invention, the processor may perform similarity comparison on road attribute information provided in the query data, based on metadata associated with a high-precision map included in the autonomous driving data set, and when a similarity is within a predetermined similarity range as a result of the similarity comparison, may detect data for construction of the training data.

In some embodiments of the present invention, the processor may perform similarity comparison on the traffic environment information provided in the query data, based on attribute information about a moving object included in the autonomous driving data set, and when a similarity is within a predetermined similarity range as a result of the similarity comparison, may detect data for construction of the training data.

A computer program according to another aspect of the present invention for solving the problem described above may be connected to a computer corresponding to hardware to execute a training data service method for operation scope-oriented autonomous driving shuttle and may be stored in a computer-readable recording medium.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a flowchart of a training data service method for operation scope-oriented autonomous driving shuttle according to an embodiment of the present invention.

FIG. 2 is a diagram illustrating an embodiment of a method of constructing training data according to an embodiment of the present invention.

FIG. 3A to 3D are diagrams for describing a process of calculating a similarity by using road shape information in an embodiment of the present invention.

FIG. 4 is a diagram illustrating an example which constructs a driving zone of a vehicle in an embodiment of the present invention.

FIG. 5 is a block diagram of a training data service method for operation scope-oriented autonomous driving shuttle according to an embodiment of the present invention.

### DETAILED DESCRIPTION OF THE INVENTION

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Herein, like reference numeral refers to like element, and “and/or” include(s) one or more combinations and each of described elements. Although “first” and “second” are used for describing various elements, but the elements are not limited by the terms. Such terms are used for distinguishing one element from another element. Therefore, a first element described below may be a second element within the technical scope of the present invention.

Unless otherwise defined, all terms (including technical and scientific terms) used herein may be used as a meaning capable of being commonly understood by one of ordinary skill in the art. Also, terms defined in dictionaries used generally are not ideally or excessively construed unless clearly and specially defined.

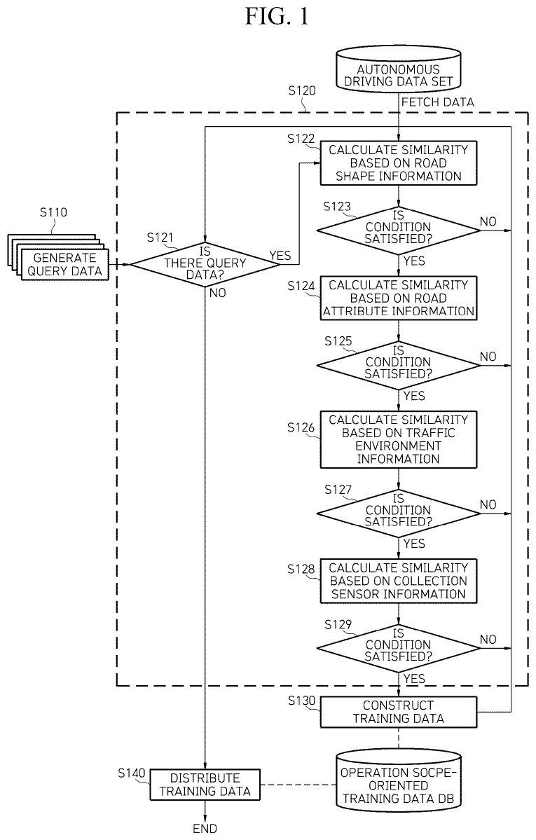

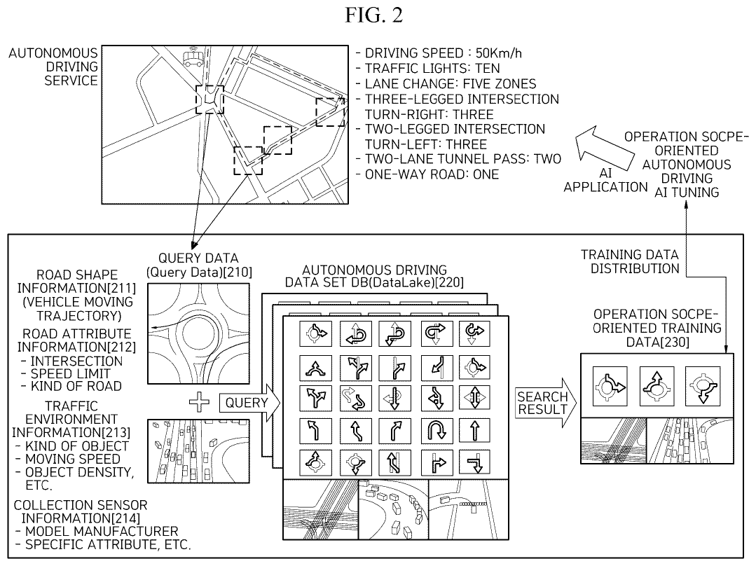

FIG. 1 is a flowchart of a training data service method for operation scope-oriented autonomous driving shuttle according to an embodiment of the present invention. FIG. 2 is a diagram illustrating an embodiment of a method of constructing training data according to an embodiment of the present invention.

Moreover, each step illustrated in FIG. 1 may be understood as being performed by a training data service system 100 described below, but is not limited thereto.

First, query data 210 including road shape information, road attribute information, traffic environment information, and collection sensor information may be generated in step S110. In this case, the query data 210 may be generated to correspond to an autonomous driving service area which is a target.

In an embodiment, by subdividing at least one of a zone and a region where autonomous driving shuttle is to be driven, the query data 210 may be configured in plurality. Each of the plurality of query data 210 may fundamentally include road shape information 211, and depending on the case, the plurality of query data 210 may include at least one of road attribute information 212, traffic environment information 213, and collection sensor information 214, for filtering of more precise training data.

As described above, an embodiment of the present invention may construct a plurality of query data 210 to subdivide a service area, and thus, may more accurately reflect a road characteristic and a traffic environment of an autonomous driving shuttle service providing area. For example, as illustrated in FIG. 2, based on data characteristics such as an intersection zone, a linear zone, a turn zone, and a junction according to a purpose to learn, a zone may be divided, and then, the query data 210 may be generated.

Moreover, in an embodiment of the present invention, the road shape information 211 may be constructed based on trajectory information about where a vehicle moves, so as to reflect road shape information similar to an autonomous driving service, and may include topology information and a geometric shape of a road. Also, the road attribute information 212 may include road characteristics such as the number of lanes, a speed limit, whether there is an intersection or not, whether there is a linear zone or not, whether there are traffic lights or not, and a crosswalk in a road. Also, the traffic environment information 213 may include the kinds of classes and moving speeds of moving objects and a density of moving objects, which are in a road zone.

Moreover, the collection sensor information 214 may fundamentally include model information and a manufacturer of a sensor. That is, although the kinds of sensors are the same, various characteristics (accuracy, resolution, noise level, sensitivity, measurement range, etc.) may differ based on a manufacturer or a model, and due to such a difference, pieces of data collected from different sensors may be different pieces of data. Therefore, an embodiment of the present invention may generate query data, based on the collection sensor information 214, and based thereon, may construct training data. For example, an embodiment of the present invention may construct query data to exclude data collected by a sensor having a specific attribute in a query process, or may construct query data to include only data collected by a specific sensor.

Subsequently, in step S120, data satisfying a condition corresponding to the query data 210 may be detected from an autonomous driving data set 220 which is previously collected. Also, training data for autonomous driving shuttle may be constructed based on the detected data in step S130.

In this case, in the autonomous driving data set 220, data may be constructed by units of scene configured with continuous frames extracted from a data log collected from constructing training data 230. Such data constructed by scene units may reflect surrounding environments and situations which an autonomous driving system actually experiences while driving. For example, the autonomous driving data set 220 may include high-precision map information including information about a road shape, data collected from various sensors such as camera/LiDAR, time stamp information including a time at which data collection is performed, information such as a position and a direction of a vehicle in each frame, a car recognized in a scene, a traffic light and a moving object such as a pedestrian, and a frame-based detection position and status information about a still object such as a traffic sign.

In an embodiment, when there is query data in step S121, a process of calculating a similarity based on road shape information to construct training data may be performed in steps S122 and S123.

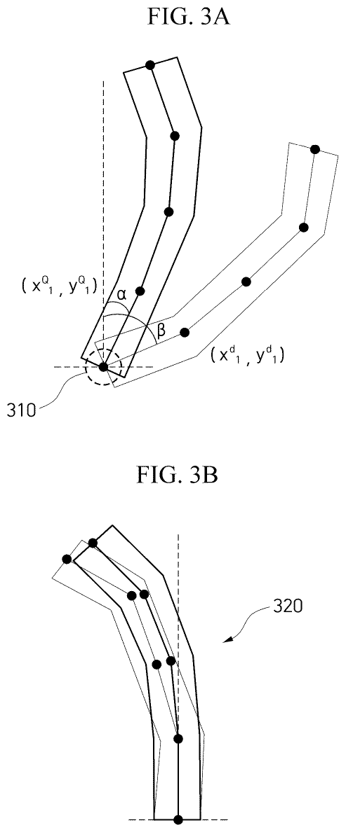

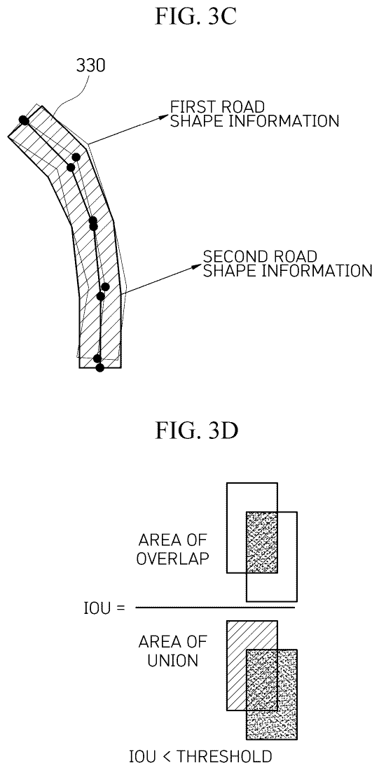

FIG. 3A to 3D are diagrams for describing a process of calculating a similarity by using road shape information in an embodiment of the present invention. FIG. 4 is a diagram illustrating an example which constructs a driving zone of a vehicle in an embodiment of the present invention.

In detail, first road shape information may be generated based on a moving trajectory of a vehicle provided in the query data and a driving zone of the vehicle corresponding to the moving trajectory, and moreover, second road shape information may be generated based on a moving trajectory of a vehicle provided in the autonomous driving data set and a driving zone of the vehicle corresponding to the moving trajectory.

Referring to FIG. 4, in the present invention, a driving zone 430 of a vehicle may extend based on width information 420 about the vehicle and a moving trajectory 410 of the vehicle determined based on position coordinate values listed by frames or times. The driving zone 430 of the vehicle may extend with the width information 420 about the vehicle and a road region where the vehicle drives actually, and based thereon, a characteristic of a driving zone may be determined through similarity comparison to detect similar data.

Referring to FIG. 3A, When first and second road shape information are generated, because a coordinate value of query data differs from a coordinate value of an autonomous driving data set, an initial position 310 in different positions may be aligned by using an original point or a middle value so as to determine a similarity. That is, because two data sets are collected or manufactured at different times and positions, a position difference may occur, and thus, it may be required to correct the position difference. For example, in a case where alignment is performed with respect to the original point, an average value of coordinate values of each of the first and second road shape information may be calculated, and based thereon, a position may be adjusted. That is, alignment may be performed by a method of subtracting the average value from each coordinate value.

Subsequently, turn conversion may be performed for alignment on a driving zone of the first road shape information and the second road shape information, where an initial position is aligned. That is, directions of two movement regions may be aligned in the same direction by using a turn conversion equation based on the following Equation 1, and thus, may be represented as in FIG. 3B (320).

$${x}^{′} = {xQ}_{1} cos ( α ) - {yQ}_{1} sin ( α ) \\ {y}^{′} = {xQ}_{1} sin ( α ) + {yQ}_{1} cos ( α ) \\ {x}^{″} = {xd}_{1} cos ( β ) - {yd}_{1} sin ( β ) \\ {y}^{″} = {xd}_{1} sin ( β ) + {yd}_{1} cos ( β ) \qquad [ Equation 1 ]$$

Subsequently, in a case where the first and second road shape information are within a predetermined similarity range, the first and second road shape information may be detected as data for constructing training data. To this end, a size of an overlap zone 330 and a size of a driving zone of each of the first and second road shape information may be calculated, may represent an area occupied by a corresponding road shape, and may represent the degree to which two driving zones overlap each other (FIG. 3C).

A similarity may be calculated as an intersection over union (IoU) 340, and the IoU may be calculated by dividing a size of an overlap zone of two driving zones by a union of the two driving zones. That is, the IoU may be calculated as “(size/overlap zone)/(union of sizes of two driving zones), and a calculated value may have a range from 0 to 1 (FIG. 3D).

For example, when a value of the IoU gets close to 1, the two driving zones may be determined to have very similar road shapes. On the other hand, when the value of the IoU gets close to 0, the two driving zones may be determined to have different road shapes. In the present invention, when the IoU is greater than a threshold value set by a user, the two driving zones may be determined to be similar in road shape and may be added to a candidate data set for constructing training data. Accordingly, the candidate data set may be constructed by detecting data including similar road shape information.

Moreover, the IoU may be calculated by aligning a movement zone with respect to a middle portion of a driving zone so as to prevent an initial error from being accumulated in a process of calculating a similarity between the two driving zones. This may be appropriately selected according to embodiments.

As described above, an embodiment of the present invention may accurately compare a similarity of road shape information to construct a candidate data set, and the autonomous driving system may secure training data which is more accurate and reliable.

Based on a candidate data set constructed based on a geometric comparison result of road shape information, an embodiment of the present invention may more reflect road attribute information and traffic environment information to finally construct a satisfying data as a operation scope-oriented data set.

To this end, an embodiment of the present invention may perform similarity comparison on road attribute information provided in query data, based on metadata associated with a high-precision map included in an autonomous driving data set, and when a similarity comparison result is within a predetermined similarity range, data for constructing training data may be detected in steps S124 and S125.

That is, a search condition may use road attribute information such as lane information, speed limit, and the kind of intersection among pieces of attribute information assigned based on a high-precision map in the autonomous driving data set.

For example, when a search condition associated with a road attribute is satisfied through comparison like that “a road should be a four or more-lane road and a four-legged intersection is under a condition where a maximum speed limit is 60 Km or less” so as to be an environment similar to current query data, a traffic environment information comparison step may be performed subsequently.

In the traffic environment information comparison step, similarity comparison may be performed on traffic environment information provided in the query data, based on attribute information about a moving object included in the autonomous driving data set, and when a similarity comparison result is within the predetermined similarity range, data for constructing training data may be detected in steps S126 and S127.

That is, such a process may be a process of reflecting attribute information about a moving object such as a vehicle or a pedestrian to filter training data constructed in the autonomous driving data set. For example, traffic situation information to be searched for may include information which may be classified as an object detection result of the training data “two or more vehicles should be in a training data set. The kind of vehicle should include a bus and a truck. One or more vehicles should stop on a shoulder at hazy weather.”.

Moreover, an embodiment of the present invention may compare a similarity based on collection sensor information, and when a similarity comparison result is within the predetermined similarity range, data for constructing training data may be detected in steps S128 and S129. As described above, this may be for detecting training data including a specific attribute of a specific sensor, or may be for constructing training data to include only data collected by a specific sensor.

Such information may be information which is constructed as an object detection result in constructing the autonomous driving data set, and data satisfying a condition provided by a user may be detected and finally stored in a operation scope-oriented training data database.

The operation scope-oriented training data database finally selected through such a process may be packaged and distributed to a consumer which needs corresponding data in step S140, and the distributed data may be applied to autonomous driving shuttle.

In addition, an embodiment of the present invention may construct training data through a comparison result obtained by comparing the autonomous driving data set with driving negotiation arbitration data or driving negotiation data between the autonomous driving shuttle and a moving object (a pedestrian or another vehicle). In this case, the driving negotiation data may be data occurring in a direct driving negotiation process between an autonomous driving system (an autonomous driving vehicle or autonomous driving shuttle) and a moving object, and such data may occur in a process where the autonomous driving system interacts with a surrounding environment and tunes driving and may be data occurring in a process where the autonomous driving system adjusts a distance to another vehicle or determines a priority with a pedestrian.

The driving negotiation arbitration data may be data occurring in an indirect driving negotiation process between the autonomous driving system and the moving object. Also, the indirect driving negotiation process may denote a case where arbitration is performed by a third agent (traffic sign, traffic light, etc.). For example, data occurring in a situation where a driving speed of the autonomous driving system is changed by a traffic sign may correspond to the driving negotiation arbitration data.

An embodiment of the present invention may compare the autonomous driving data set with the driving negotiation arbitration data and the driving negotiation data to construct training data, and thus, may allow the autonomous driving system to better understand and learn a situation which interacts with a surrounding environment in actual driving. This may enable autonomous driving shuttle to perform stable and efficient driving which corresponds to various situations.

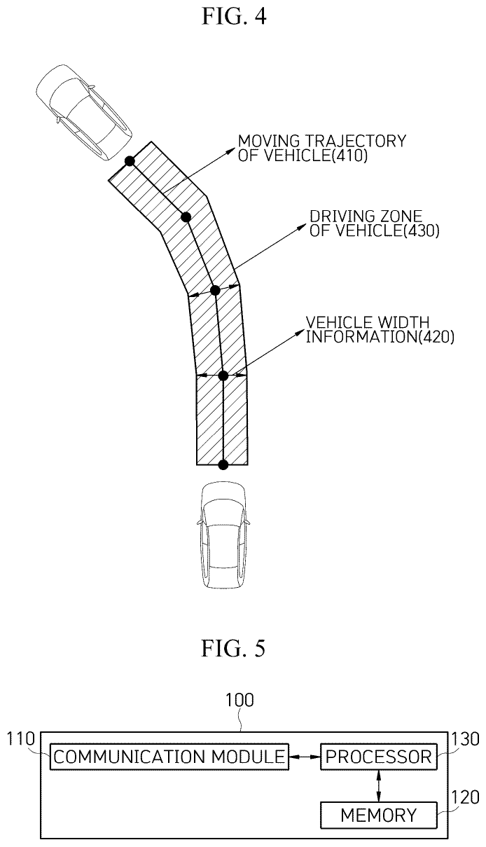

Furthermore, in the above description, steps S110 to steps S140 may be more divided into additional steps, or may be combined as fewer steps, based on an implementation example of the present invention. Also, some steps may be omitted depending on the case, or the order of steps may be changed. Also, despite other omitted details, the descriptions of FIGS. 1 to 4 and the description of FIG. 5 may be mutually applied to each other.

FIG. 5 is a block diagram of a training data service method for operation scope-oriented autonomous driving shuttle according to an embodiment of the present invention.

A training data service system 100 according to an embodiment of the present invention may include a communication module 110, a memory 120, and a processor 130.

The communication module 110 may collect an autonomous driving data set from autonomous driving vehicles to construct training data and may distribute the training data to autonomous driving shuttle. The communication module 110 may include a wired communication module and a wireless communication module. The wired communication module may be implemented with a power cable communication device, a telephone cable communication device, cable home (MoCA), Ethernet, IEEE1294, an integrated cable home network, an RS-485 control device, and/or the like. Also, the wireless communication module may be implemented with a module for implementing a function of each of wireless LAN (WLAN), Bluetooth, HDR WPAN, UWB, ZigBee, Impulse Radio, 60 GHz WPAN, Binary-CDMA, wireless USB technology, wireless HDMI technology, 5^{th} generation communication (5G), long term evolution-advanced (LTE-A), (long term evolution (LTE), and wireless fidelity (Wi-Fi).

The memory 120 may store a program for constructing training data. Here, the memory 120 may be a generic name for a volatile storage device and a non-volatile storage device which continuously maintains information stored therein even when power is not supplied thereto. For example, examples of the memory 120 may include NAND flash memory such as compact flash (CF) card, secure digital (SD) card, memory stick, solid-state drive (SSD), and micro SD card, magnetic computer memory device such as hard disk drive (HDD), and optical disc drive such as CD-ROM and DVD-ROM.

The processor 130 may execute software such as a program to control at least one other element (for example, a hardware or software element) of the training data service system 100 and may perform various processing or arithmetic operations.

An embodiment of the present invention described above may be implemented as a program (or an application) and may be stored in a medium, so as to be executed in connection with a server which is hardware.

The program described above may include a code encoded as a computer language such as C, C++, JAVA, Ruby, or machine language readable by a processor (CPU) of a computer through a device interface of the computer, so that the computer reads the program and executes the methods implemented as the program. Such a code may include a functional code associated with a function defining functions needed for executing the methods, and moreover, may include an execution procedure-related control code needed for executing the functions by using the processor of the computer on the basis of a predetermined procedure. Also, the code may further include additional information, needed for executing the functions by using the processor of the computer, or a memory reference-related code corresponding to a location (an address) of an internal or external memory of the computer, which is to be referred to by a media. Also, when the processor needs communication with a remote computer or server so as to execute the functions, the code may further include a communication-related code corresponding to a communication scheme needed for communication with the remote computer or server and information or a media to be transmitted or received in performing communication, by using a communication module of the computer.

The stored medium may denote a device-readable medium semi-permanently storing data, instead of a medium storing data for a short moment like a register, a cache, and a memory. In detail, examples of the stored medium may include read only memory (ROM), random access memory (RAM), CD-ROM, a magnetic tape, floppy disk, and an optical data storage device, but are not limited thereto. That is, the program may be stored in various recording mediums of various servers accessible by the computer or various recording mediums of the computer of a user. Also, the medium may be distributed to computer systems connected to one another over a network and may store a code readable by a computer in a distributed scheme.

The foregoing description of the present invention is for illustrative purposes, those with ordinary skill in the technical field of the present invention pertains in other specific forms without changing the technical idea or essential features of the present invention that may be modified to be able to understand. Therefore, the embodiments described above, exemplary in all respects and must understand that it is not limited. For example, each component may be distributed and carried out has been described as a monolithic and describes the components that are to be equally distributed in combined form, may be carried out.

Because general autonomous driving training data consists of generalized data including various roads and traffic environments without division of a service area, there may be a limitation in autonomous driving in a specific zone or path, and due to this, data deviation and data unbalance may occur, causing a reduction in autonomous driving learning performance.

However, in an embodiment of the present invention, training data of a similar environment may be constructed based on a road shape and a traffic environment of a specific zone or path to service, and thus, such a limitation may be solved. That is, as training data suitable for a corresponding service area is constructed, autonomous driving vehicles may more accurately learn an environment which should actually drive.

The construction of training data suitable for a specific zone may contribute to remove data deviation and data unbalance. By using training data suitable for a specific zone, biased learning or the insufficiency of information about a specific environment may be prevented in learning, thereby providing a positive effect in performance enhancement of an autonomous driving system.

As described above, in an embodiment of the present invention, fine-tuning of an autonomous driving vehicle may be effectively performed based on a specific zone or path, and stable and accurate training data suitable for a corresponding zone may be provided, thereby improving the performance of an autonomous driving system.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A training data service method for operation scope-oriented autonomous driving shuttle, performed by a computer, the training data service method comprising:
generating query data including road shape information, road attribute information, traffic environment information, and collection sensor information;
detecting data, satisfying a condition corresponding to the query data, from a previously collected autonomous driving data set; and
constructing training data for an autonomous driving shuttle, based on the detected data.

2. The training data service method of claim 1, wherein the generating of the query data comprises generating a plurality of query data by subdividing at least one of a zone and a region, where the autonomous driving shuttle is to be driven, and
each of the plurality of query data fundamentally comprises road shape information, and depending on the case, each of the plurality of query data comprises at least one of road attribute information, traffic environment information, and collection sensor information.

3. The training data service method of claim 1, wherein the detecting of the data satisfying the condition comprises:
generating first road shape information, based on a moving trajectory of a vehicle provided in the query data and a driving zone of the vehicle corresponding to the moving trajectory;
generating second road shape information, based on a moving trajectory of the vehicle provided in the autonomous driving data set and a driving zone of the vehicle corresponding to the moving trajectory; and
when the first and second road shape information are within a predetermine similarity range, detecting data for construction of the training data.

4. The training data service method of claim 3, wherein each of the generating of the first road shape information and the generating of the second road shape information comprises reflecting width information about the vehicle in the moving trajectory of the vehicle to generate the driving zone of the vehicle.

5. The training data service method of claim 3, wherein the detecting of the data satisfying the condition comprises:
aligning initial position of each of the first road shape information and the second road shape information; and
performing turn conversion for alignment on the driving zone of each of the first road shape information and the second road shape information where the initial position is aligned.

6. The training data service method of claim 3, wherein the detecting of the data for construction of the training data comprises calculating a size of an overlap zone of the first and second road shape information, and when the size of the overlap zone is within a predetermined similarity range, detecting the data for construction of the training data.

7. The training data service method of claim 1, wherein the detecting of the data satisfying the condition comprises:
performing similarity comparison on road attribute information provided in the query data, based on metadata associated with a high-precision map included in the autonomous driving data set; and
when a similarity is within a predetermined similarity range as a result of the similarity comparison, detecting data for construction of the training data.

8. The training data service method of claim 1, wherein the detecting of the data satisfying the condition comprises:
performing similarity comparison on the traffic environment information provided in the query data, based on attribute information about a moving object include in the autonomous driving data set; and
when a similarity is within a predetermined similarity range as a result of the similarity comparison, detecting data for construction of the training data.

9. A training data service system for operation scope-oriented autonomous driving shuttle, the training data service system comprising:
a communication module configured to collect an autonomous driving data set from an autonomous driving vehicle to construct training data and distribute the training data to an autonomous driving shuttle;
a memory configured to store a program for construction of the training data; and
a processor configured to generate query data including road shape information, road attribute information, traffic environment information, and collection sensor information by executing the program stored in the memory, detect data satisfying a condition corresponding to the query data from a previously collected autonomous driving data set, construct training data for the autonomous driving shuttle, based on the detected data, and distribute the constructed training data to a corresponding autonomous driving shuttle.

10. The training data service system of claim 9, wherein the processor generates a plurality of query data by subdividing at least one of a zone and a region, where the autonomous driving shuttle is to be driven, and
each of the plurality of query data fundamentally comprises road shape information, and depending on the case, each of the plurality of query data comprises at least one of road attribute information, traffic environment information, and collection sensor information.

11. The training data service system of claim 9, wherein the processor generates first road shape information, based on a moving trajectory of a vehicle provided in the query data and a driving zone of the vehicle corresponding to the moving trajectory, generates second road shape information, based on a moving trajectory of the vehicle provided in the autonomous driving data set and a driving zone of the vehicle corresponding to the moving trajectory, and when the first and second road shape information are within a predetermine similarity range, detects data for construction of the training data.

12. The training data service system of claim 11, wherein the processor aligns an initial position of each of the first road shape information and the second road shape information and performs turn conversion for alignment on the driving zone of each of the first road shape information and the second road shape information where the initial position is aligned.

13. The training data service system of claim 11, wherein the processor calculates a size of an overlap zone of the first and second road shape information, and when the size of the overlap zone is within a predetermined similarity range, detects the data for construction of the training data.

14. The training data service system of claim 9, wherein the processor performs similarity comparison on road attribute information provided in the query data, based on metadata associated with a high-precision map included in the autonomous driving data set, and when a similarity is within a predetermined similarity range as a result of the similarity comparison, detects data for construction of the training data.

15. The training data service system of claim 9, wherein the processor performs similarity comparison on the traffic environment information provided in the query data, based on attribute information about a moving object include in the autonomous driving data set, and when a similarity is within a predetermined similarity range as a result of the similarity comparison, detects data for construction of the training data.
